(19) United States
(12) Patent Application Publication
(10) Pub. No.: US 2019/0373062 A1
(43) Pub. Date: Dec. 5, 2019

(54) TERMINAL FOR REMOTE MONITORING SYSTEM, PROGRAM FOR REMOTE MONITORING, AND REMOTE MONITORING SYSTEM

(71) Applicant: MCREST LTD., Tokyo (JP)

(72) Inventor: Kazuhiro KOZAWA, Tokyo (JP)

(73) Assignee: MCREST LTD., Tokyo (JP)

(21) Appl. No.: 16/310,716

(22) PCT Filed: Jun. 14, 2017
(86) PCT No.: PCT/JP2017/022026

§ 371 Date: Aug. 22, 2019

(30) Foreign Application Priority Data
Jun. 15, 2016 (JP) 2016-118590
Apr. 27, 2017 (JP) 2017-087977

(51) Int. Cl. H04L 29/08; H04L 12/46; H04L 12/24; G06F 3/0482; G06F 3/0481

(52) U.S. Cl. CPC H04L 67/141; H04L 67/10; H04L 67/143; H04L 12/4633; G06F 3/14; G06F 3/0482; G06F 3/04817; H04L 67/12; H04L 41/22

(57) ABSTRACT

A remote monitoring system that allows a user terminal to access multiple terminals connected to the Internet through an Internet service provider at a desired timing. The remote monitoring system includes multiple terminals that are connected to the Internet through an Internet service provider (ISP) having a global IP address and assigned private IP addresses, a cloud server connected to the Internet, and user terminals connected to the cloud server. The cloud server assigns a first connection port to one of the terminals and assigns a second connection port to a user terminal. The one terminal and the user terminal communicate with each other through the first connection port, second connection port, and cloud server.

### TECHNICAL FIELD

The present invention relates to a remote monitoring system that monitors terminals connected through the Internet or the like and, in particular, to a remote monitoring system that is able to access terminals to be monitored, at any timing.

### BACKGROUND ART

A technology called Internet of Things (IoT) has been attracting attention in the fields of monitoring and the like in recent years. IoT is a mechanism in which uniquely identifiable computers, devices, or the like are connected to the Internet and control each other by exchanging information with each other. The “devices” here include all things, including measuring devices, such as sensors, monitoring cameras, and home appliances, such as air-conditioners or cookers.

For example, in an information processing system called Industrial Internet, IoT connects devices or humans, acquires data in real time, and takes action on the basis of the data. For this reason, IoT is expected to produce advantageous effects, such as improvements in the operating efficiency of the devices and reductions in the waiting time of humans.

Examples of proposed IoT-related technologies include Patent Literature 1 and Patent Literature 2.

Patent Literature 1 discloses the following technology: with respect to a workflow in which the operation of IoT devices is controlled over multiple stages, a workflow management apparatus holds a condition for making a transition from each stage to the next stage and stage information indicating the current stage of the workflow; if there is a partial order relation among the stages, if the first stage and second stage cannot be compared, the third stage can be performed subsequent to the first stage, and if the third stage cannot be compared with the second stage, the workflow management apparatus updates the stage information such that if the transition condition of the first stage is satisfied but the transition of the second stage is not satisfied, the workflow indicates that the workflow is the third stage subsequent to the first stage and is also the second stage. The stages here refer to a temperature collection stage, an average temperature calculation stage, an energy accounting calculation stage, and the like.

Patent Literature 2 discloses a technology including selecting a solution template related to a particular automatic interaction device configuration between two or more IoT devices; if a complete solution template is selected, deploying the device configuration; otherwise, selecting IoT devices; accessing device functions in an IoT database of the selected IoT devices; setting a network connection between the selected IoT devices; simulating the device configuration in the IoT database; and determining whether the device configuration is available; if the device configuration is not available, reconfiguring the device configuration so that the device configuration includes a replacement IoT device; and if the device configuration is available, deploying the device configuration. The device configuration here refers to establishing a communication connection between two or more IoT devices through a network.

### CITATION LIST

### Patent Literature

Patent Literature 1: Japanese Unexamined Patent Application Publication No. 2015-204013

Patent Literature 2: Japanese Unexamined Patent Application Publication No. 2016-45964

### SUMMARY OF INVENTION

### Technical Problem

However, Patent Literature 1 only discloses the workflow management apparatus that controls the operation of IoT devices over multiple stages. That is, this workflow management apparatus is not enough to be applied to a remote monitoring system in which IoT devices transmit the states of the target devices to be monitored, to a cloud server through an Internet service provider (ISP) and the Internet and the cloud server transmits the states of the target devices to the user terminal of the owner of the target devices or the user terminal of a business entity that undertakes the maintenance of the target devices, periodically (in a predetermined cycle).

Cases have been remarkably increased in which, in such a remote monitoring system, multiple terminals (IoT devices) connected to an Internet service provider (ISP) having one global IP address are assigned different private IP addresses by the Internet service provider (ISP). However, when the user terminal needs to access the multiple terminals (IoT devices), it has difficulty in accessing the terminals (IoT devices) at a desired timing. This is because although the user terminal can access the Internet service provider (ISP) through the Internet, it has not acquired the private IP addresses assigned to the terminals (IoT devices) connected to the Internet service provider (ISP). In Patent Literature 1, no consideration is given to addressing such a situation.

Patent Literature 2 allows two or more IoT devices to establish a communication connection with each other. However, as described above, when the user terminal needs to access the multiple terminals (IoT devices), it has difficulty in accessing the terminals (IoT devices) at a desired timing. This is because although the user terminal can access the Internet service provider (ISP) through the Internet, it has not acquired the private IP addresses assigned to the terminals (IoT devices) connected to the Internet service provider (ISP). In Patent Literature 2, no consideration is given to addressing such a situation.

In view of the foregoing, an object of the present invention is to provide terminals for remote monitoring systems, remote monitoring program, and remote monitoring system that allow a user terminal to access multiple terminals connected to the Internet through an Internet service provider at a desired timing.

### Solution to Problem

To solve the above problems, a remote monitoring system of the present invention includes multiple terminals connected to the Internet through an Internet service provider having a global IP address, the terminals being assigned private IP addresses, a cloud server connected to the Internet, and a user terminal connected to the cloud server. The cloud server assigns a first connection port to one of the terminals and assigns a second connection port to the user terminal. The one terminal and the user terminal communicate with each other through the first connection port, the second connection port, and the cloud server.

In another aspect of the remote monitoring system of the present invention, the cloud server randomly assigns the first connection port and the second connection port to the one terminal and the user terminal.

In another aspect of the remote monitoring system of the present invention, the user terminal transmits a request to access the one of the terminals, to the cloud server.

In the remote monitoring system of the present invention, the cloud server includes a connection port assigner configured to, for each of a request to access the one of the terminals transmitted from the user terminal, assign a different first connection port to the one of the terminals and assign a different second connection port to the user terminal.

In another aspect of the remote monitoring system of the present invention, the cloud server includes a connection time manager configured to be able to, for a predetermined time, continue a communication between the one terminal to which the first connection port is assigned and the user terminal to which the second connection port is assigned.

In another aspect of the remote monitoring system of the present invention, the user terminal transmits, to the cloud server, at least an IP address of the user terminal, one of the terminals, the one terminal being a terminal that the user terminal desires to access, and a connection time.

In another aspect of the remote monitoring system of the present invention, upon a lapse of the connection time transmitted from the user terminal, the connection time manager terminates a communication between the one terminal and the user terminal through the first connection port and the second connection port.

In another aspect of the remote monitoring system of the present invention, the terminals are connected to measuring devices and/or imaging devices wired or wirelessly and transmit measurement values of target terminals or target devices measured by the measuring devices and/or image data of target terminals or target devices captured by the imaging devices to the cloud server in a predetermined cycle through the Internet service provider and the Internet.

In another aspect of the remote monitoring system of the present invention, the user terminal transmits, to the cloud server, a request to access a lower-order device connected to the one of the terminals, and upon receipt of the access request from the cloud server, the one terminal connects a communication with the user terminal to the lower-order device.

In another aspect of the remote monitoring system of the present invention, the user terminal displays a terminal selection screen for selecting one of the terminals and a connection destination selection screen for selecting a connection destination of the one terminal selected on the terminal selection screen and, when a lower-order device connected to the one terminal is selected as the connection destination on the connection destination selection screen, transmits a request to access the lower-order device, to the cloud server.

Multiple terminals for use in remote monitoring systems of the present invention are connected to the Internet through an Internet service provider having a global IP address and assigned private IP addresses. The terminals are connectable to a cloud server through the Internet and are able to communicate with a user terminal through the cloud server. The terminals are assigned a first connection port different from a second connection port assigned to the user terminal by the cloud server and are able to communicate with the user terminal through the first connection port and the second connection port.

In another aspect of the multiple terminals for use in remote monitoring systems of the present invention, the first connection port different from the second connection port assigned to the user terminal by the cloud server is randomly assigned.

In another aspect of the multiple terminals for use in remote monitoring systems of the present invention, the terminals continuously communicate with the user terminal to which the second connection port is assigned, through the first connection port for a predetermined time.

In another aspect, the multiple terminals for use in remote monitoring systems of the present invention each include a tunneling connection termination executor configured to, upon a lapse of a predetermined time, terminate a tunneling connection in which the terminals communicate with the user terminal to which the second connection port is assigned, through the first connection port.

In another aspect of the multiple terminals for use in remote monitoring systems of the present invention, the terminals each have a lower-order device connected thereto and, upon receipt of a request to access the lower-order device, from the cloud server, enable the user terminal and the lower-order device to communicate with each other.

A remote monitoring program of the present invention causes a processor to perform functions of assigning a first connection port to one of multiple terminals connected to the Internet through an Internet service provider having a global IP address, the terminals being assigned private IP addresses, assigning a second connection port to a user terminal connected to a cloud server connected to the Internet, and randomly assigning the first connection port and the second connection port.

Another aspect of the remote monitoring program of the present invention causes a processor to perform a function of, for a predetermined time, continuing a communication between the one terminal to which the first connection port is assigned and the user terminal to which the second connection port is assigned.

### Advantageous Effects of Invention

According to the present invention, terminals for remote monitoring systems, remote monitoring program, and remote monitoring system can be provided that allow a user terminal to access multiple terminals connected to the Internet through an Internet service provider at a desired timing.

Problems, configurations, and advantageous effects other than those described above will be clarified in the description of the following embodiment.

### BRIEF DESCRIPTION OF THE DRAWINGS

FIG. 1 is an overall schematic configuration drawing of a remote monitoring system according to an embodiment of the present invention.

FIG. 2 is a function block diagram of a cloud server shown in FIG. 1.

FIG. 3 is a function block diagram of a terminal shown in FIG. 1.

FIG. 4 is a function block diagram of a user terminal shown in FIG. 1.

FIG. 5 is a schematic sequence diagram of the remote monitoring system shown in FIG. 1.

FIG. 6 is a schematic sequence diagram of the remote monitoring system shown in FIG. 1.

FIG. 7 is a schematic sequence diagram of the remote monitoring system shown in FIG. 1.

FIG. 8 is a schematic sequence diagram of the remote monitoring system when the user instructs the cloud server to terminate tunneling connection.

FIG. 9 is a schematic sequence diagram of the remote monitoring system when the tunneling connection is terminated using a timer function.

FIG. 10 is a flowchart showing the process flow of the cloud server shown in FIG. 2.

FIG. 11 is a flowchart showing the process flow of the terminal shown in FIG. 3.

FIG. 12 is a flowchart showing the process flow of the user terminal shown in FIG. 4.

FIG. 13 is a diagram showing an example of screens in a modification of the remote monitoring system shown in FIG. 1.

### DESCRIPTION OF EMBODIMENTS

In the present specification, a “remote monitoring system” refers to a system that monitors the states of target terminals or target devices and/or provides maintenance of the target terminals or target devices or information about the maintenance, and includes a “remote maintenance system” and a “remote monitoring system” in a narrow sense.

Now, an embodiment of the present invention will be described with reference to the drawings.

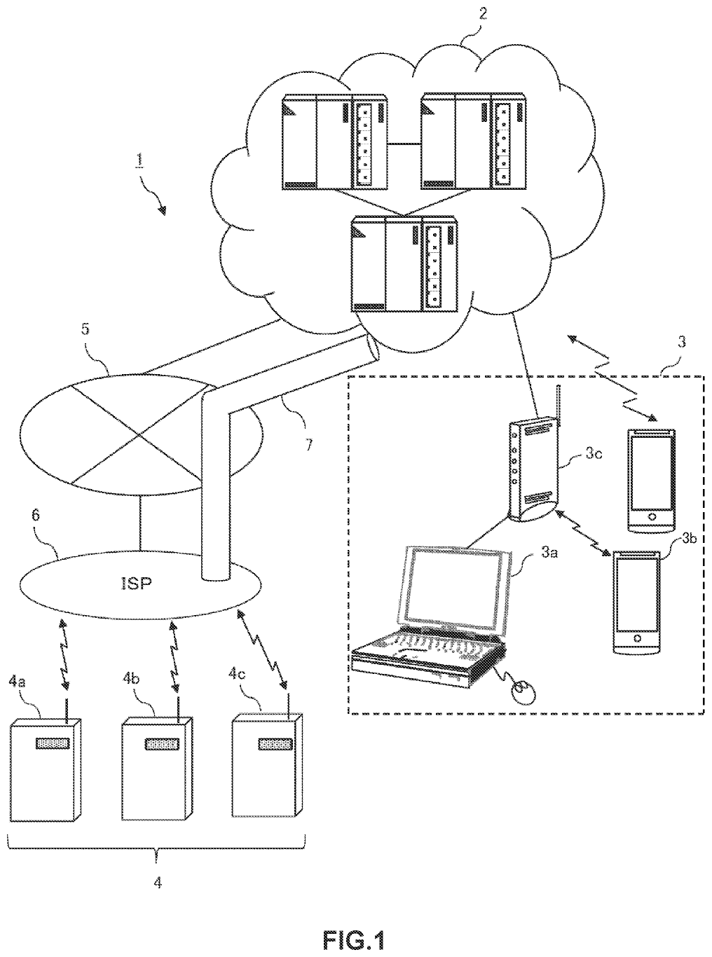

FIG. 1 is an overall schematic configuration drawing of a remote monitoring system according to an embodiment of the present invention. As shown in FIG. 1, a remote monitoring system 1 includes a user terminal 3a, which is a personal computer owned by a user 3, a user terminal 3b, such as a smartphone (mobile phone) or tablet, a router 3c, a cloud server 2, remote monitoring system terminals 4 including multiple terminals 4a to 4c, the Internet 5, and an Internet service provider (ISP) 6.

The cloud server 2 is a virtual server constructed by connecting multiple servers, and FIG. 1 shows an example of a cloud server 2 constructed by connecting three servers. However, the cloud server 2 need not be constructed by three servers as shown in FIG. 1 and only has to be constructed by multiple servers. The number of servers is set appropriately.

The user terminal 3a and user terminal 3b are connected to the cloud server 2 through the router 3c or general public line. The user terminal 3a and user terminal 3b, and the router 3c are communicatively connected through, for example, Wi-Fi (a registered trademark) or a wired local area network (LAN).

The terminals 4 including the terminals 4a to 4c (to be discussed later) are wired or wirelessly connected to cameras serving as imaging devices or measuring devices (not shown), which are lower-order devices. Image data captured by the cameras or measurement values measured by the measuring devices (the image data or measurement values is hereafter simply referred to as “measurement values” unless otherwise specified) is transmitted to the Internet service provider (ISP) 6 in a predetermined cycle through, for example, a wireless communication network, such as a 3G network.

The Internet service provider (ISP) 6 transmits the measurement values received from the terminals 4 including the terminals 4a to 4c to the cloud server 2 through the Internet 5. That is, the remote monitoring system 1 shown in FIG. 1 is one example of a system configuration in which the IoT terminals 4 transmit measurement values to the cloud server 2 in a predetermined cycle using the Internet service provider (ISP) 6 and Internet 5 as the uplink.

The user terminal 3a or user terminal 3b transmits a request to access a desired terminal 4 (i.e., one of the terminals) to the cloud server 2 at the timing when the terminals 4 transmit measurements values in the predetermined cycle through the uplink, or at another timing.

In response to the access request, the cloud server 2 randomly assigns connection ports to the user terminal 3a or user terminal 3b and the one of the terminals 4a to 4c included in the terminals 4. The cloud server 2 then uses tunneling 7 to allow the user terminal 3a or user terminal 3b and the one of the terminals 4a to 4c included in the terminals 4 to communicate with each other through the Internet 5 and Internet service provider (ISP) 6.

Thus, the user terminal 3a or user terminal 3b and the one of the terminals 4a to 4c included in the terminals 4 are, for example, SSH (secure shell) connected and therefore all communications on the network, including authentication parts such as a password, are encrypted, allowing for safe communications.

The Internet service provider (ISP) 6 is assigned a unique global Internet protocol (IP) address. The terminals 4a to 4c included in the terminals 4 connected to the Internet service provider (ISP) 6 through a wireless communication network, such as a 3G network, are assigned respective private Internet protocol (IP) addresses by the Internet service provider (ISP) 6.

These IP addresses are, for example, IPv4 addresses, which are 32-bit numbers, or IPv6 addresses, which are 128-bit numbers. The private IP addresses assigned to the terminals 4a to 4c included in the terminals 4 are, for example, “10.0.0.0” to “10.255.255.255” (class A), “172.16.0.0” to “172.32.255.255” (class B), or “192.168.0.0” to “192.168.255.255” (class C).

The Internet service provider (ISP) 6 includes a broadband router (not shown). The broadband router has a network address translation (NAT) function that when the terminals 4a to 4c included in the terminals 4 transmit measurement values to the cloud server 2 in the predetermined cycle using the Internet 5 as the uplink, translates the private IP addresses assigned to the terminals 4a to 4c to global IP addresses, or a network address port translation (NAPT) function that translates the respective private IP addresses to different port numbers.

### Cloud Server

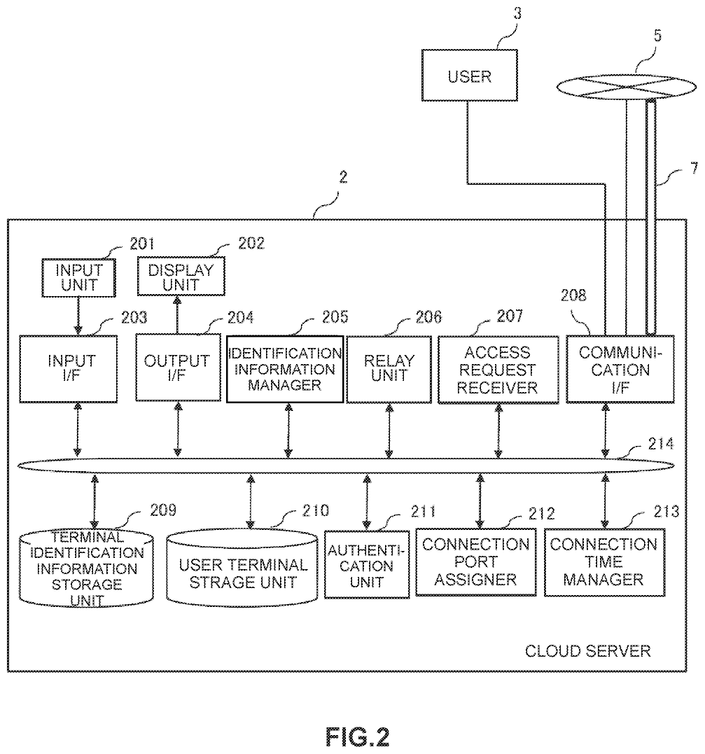

FIG. 2 is a function block diagram of the cloud server shown in FIG. 1. As shown in FIG. 2, the cloud server 2 includes an input unit 201, a display unit 202, an input I/F 203, an output I/F 204, an identification information manager 205, a relay unit 206, an access request receiver 207, a communication I/F 208, a terminal identification information storage unit 209, a user terminal storage unit 210, an authentication unit 211, a connection port assigner 212, a connection time manager 213, and an internal bus 214 that connects these components to each other. The identification information manager 205, relay unit 206, access request receiver 207, authentication unit 211, connection port assigner 212, and connection time manager 213 are implemented by, for example, memories (not shown), such as a ROM, which stores programs, and a RAM, which temporarily stores data or the like under computation, and a processor (not shown), such as a CPU, that reads and executes the programs stored in the ROM.

The terminal identification information storage unit 209 stores unique identifiers that are assigned to the terminals 4a to 4c included in the terminals 4 and consist of alphanumeric characters.

The user terminal storage unit 210 stores at least user information, connection authority, identification information, and the like of the user terminal 3a and user terminal 3b, which are connectable to the cloud server 2.

The identification information manager 205 reads the identification information assigned to the terminals 4a to 4c and/or the identification information of the user terminal 3a and user terminal 3b from the terminal identification information storage unit 209 and/or user terminal storage unit 210 through the internal bus 214 as necessary. If a user terminal connectable to the cloud server 2 is added and identification information of the user terminal, user information such as a user name, and the like are inputted through the input unit 201 and input I/F 203, the identification information manager 205 updates the user terminal storage unit 210 by registering the identification information of the user terminal and the like in the user terminal storage unit 210 through the internal bus 214. Similarly, if a new terminal 4 is added and identification information of the terminal 4 is inputted through the input unit 201 and input I/F 203, the identification information manager 205 updates the terminal identification information storage unit 209 by registering the identification information of the terminal 4 in the terminal identification information storage unit 209 through the internal bus 214.

The access request receiver 207 receives, from the user terminal 3a or user terminal 3b, information of a terminal 4 that the user terminal 3a or user terminal 3b desires to access, the desired connection time, and the IP address of the user terminal 3a or user terminal 3b itself through the communication I/F 208 and internal bus 214. The access request receiver 207 also receives a tunneling connection termination request from the user terminal 3a or user terminal 3b through the communication I/F 208 and internal bus 214.

The authentication unit 211 encrypts (e.g., SSH) authentication information for allowing a terminal 4 to access the cloud server 2, transmits the encrypted authentication information to the terminal 4 through the internal bus 214 and communication I/F 208, and determines whether tunneling can be performed, on the basis of the authentication information from the terminal 4.

Each time an access request is received, the connection port assigner 212 defines one of two connection ports represented by two numbers randomly selected between, for example, 10000 and 65535 as a first connection port and defines the other connection port as a second connection port. The connection port assigner 212 then assigns the first connection port to one of the terminals 4a to 4c included in the terminals 4 and the second connection port to the user terminal 3a or user terminal 3b.

During tunneling, the relay unit 206 relays a maintenance/situation-grasp work request transmitted to the second connection port by the user terminal 3a or user terminal 3b, from the second connection port to the first connection port and transmits the request to one of the terminals 4a to 4c included in the terminals 4. Also, the relay unit 206 relays measurement values transmitted to the first connection port by one of the terminals 4a to 4c included in the terminals 4 as a result of the maintenance/situation-grasp work request, from the first connection port to the second connection port and transmits the measurement values to the user terminal 3a or user terminal 3b. Upon establishment of a tunneling connection, the relay unit 206 changes the tunneling connection status from unconnected to connected.

The connection time manager 213 has a function of monitoring the tunneling connection time. Specifically, the connection time manager 213 starts a timer (not shown) when starting tunneling, forcibly terminates the tunneling connection upon a lapse of a predetermined time (e.g., several minutes to several tens of minutes), and changes the tunneling connection status from connected to unconnected.

The cloud server 2 may further include a storage unit (not shown) that stores history information as to when which user terminal has accessed (has been tunneling connected to) which terminal 4. The cloud server 2 may also have a function of periodically monitoring the terminals 4 using PING, or TCP port. Specifically, the cloud server 2 may have a function of transmitting PING packets to the terminals 4 or TCP-connecting to the terminals 4 and, if the PING packet is not returned from any terminal 4 or TCP connection to any terminal 4 fails, notifying the user terminals that the terminal 4 is in an abnormal state, using an email or the like.

### Terminals

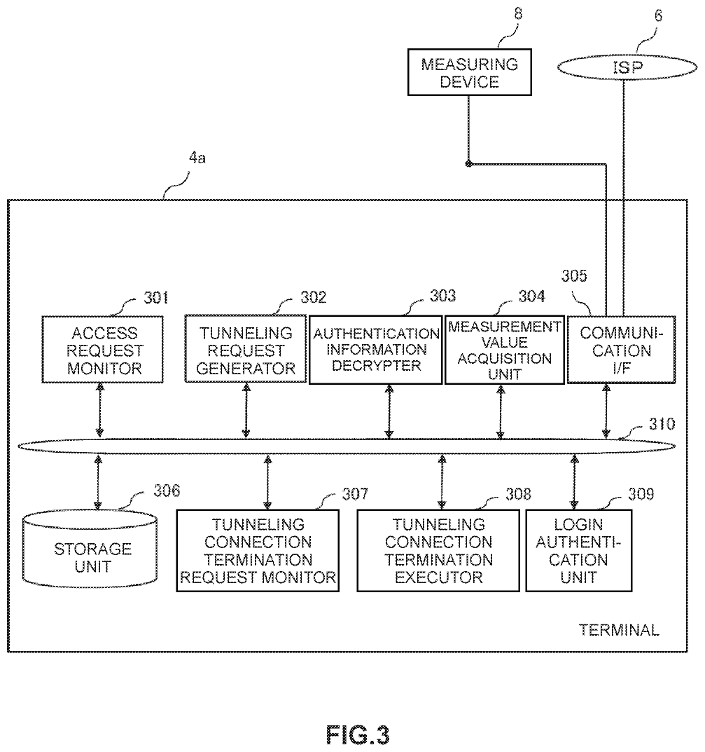

FIG. 3 is a function block diagram of a terminal 4 shown in FIG. 1. While FIG. 3 shows a function block diagram of the terminal 4a as an example, the same applies to the other terminals 4b and 4c. As shown in FIG. 3, the terminal 4a includes an access request monitor 301, a tunneling request generator 302, an authentication information decrypter 303, a measurement value acquisition unit 304, a communication I/F 305, a storage unit 306, a tunneling connection termination request monitor 307, a tunneling connection termination executor 308, a login authentication unit 309, and an internal bus 310 that connects these components to each other. The access request monitor 301, tunneling request generator 302, authentication information decrypter 303, measurement value acquisition unit 304, tunneling connection termination request monitor 307, tunneling connection termination executor 308, and login authentication unit 309 are implemented by, for example, memories (not shown), such as a ROM, which stores programs, and a RAM, which temporarily stores data or the like under computation, and a processor (not shown), such as a CPU, that reads and executes a program (i.e., a remote monitoring program) stored in the ROM.

The access request monitor 301 monitors access requests by inquiring of the cloud server 2 whether an access request has been received from the user terminal 3a or user terminal 3b, in a predetermined cycle through the communication I/F 305 and Internet service provider (ISP) 6 and receiving a response from the cloud server 2.

If tunneling is required as a result of monitoring by the access request monitor 301, the authentication information decrypter 303 receives encrypted authentication information from the cloud server 2 through the communication I/F 305 and decrypts the received encrypted authentication information. The authentication information decrypter 303 then transmits the decrypted authentication information to the cloud server 2 through the communication I/F 305 and Internet service provider (ISP) 6 using, for example, SSH.

If tunneling is required as a result of monitoring by the access request monitor 301, the tunneling request generator 302 generates a tunneling request. The tunneling request generator 302 then transmits the generated tunneling request to the cloud server 2 through the communication I/F 305 and Internet service provider (ISP) 6 using, for example, SSH.

The login authentication unit 309 transmits a request to transmit the ID and password of a user terminal to which the terminal 4a is to be tunneling-connected, to the cloud server 2 and performs login authentication of that user terminal on the basis of the ID and password received from the cloud server 2.

The measurement value acquisition unit 304 acquires a measurement value of the target terminal or target terminal measured by a measuring device 8 through the communication I/F 305, as well as writes the measurement value into a predetermined storage area of the storage unit 306 through the internal bus 310. The measurement value acquisition unit 304 transmits a measurement value to the cloud server 2 in a predetermined cycle through the communication I/F 305 and the Internet service provider (ISP) 6 and Internet 5 serving as the uplink using IoT. The measurement value acquisition unit 304 also receives a maintenance/situation-grasp work request (to be discussed later in detail) from a user terminal through the communication I/F 305, reads a measurement value stored in the storage unit 306 in response to the work request, and transmits it to the cloud server 2. The measurement value acquisition unit 304 may read the measurement value at a timing different from the above timing and transmit it to the cloud server 2. Note that the measurement value acquisition unit 304 may be configured to perform processing, such as noise removal, on the acquired measurement value.

In the storage unit 306, the measurement values of the target terminal or target device measured by the measuring device 8 are each stored so as to be associated with the date and time.

The tunneling connection termination request monitor 307 inquires of the cloud server 2 whether a tunneling connection termination request has been received, in a predetermined cycle through the communication I/F 305, Internet service provider (ISP) 6, and Internet 5. If a tunneling connection termination request has been received, the tunneling connection termination request monitor 307 transmits information to that effect to the tunneling connection termination executor 308 through the internal bus 310.

The tunneling connection termination executor 308 receives the information indicating that a tunneling connection termination request has been received, from the tunneling connection termination request monitor 307 through the internal bus 310, immediately terminates the tunneling connection, and transmits information or signal indicating that the tunneling connection has been terminated, to the cloud server 2 through the communication I/F 305, Internet service provider (ISP) 6, and Internet 5. The tunneling connection termination executor 308 also includes a timer (not shown). The tunneling connection termination executor 308 starts the timer such that the tunneling connection is terminated upon a lapse of the connection time acquired from the cloud server 2 through the communication I/F 305, terminates the tunneling connection upon expiration of the timer (upon a lapse of the connection time), and transmits information or signal indicating that the tunneling connection has been terminated, to the cloud server 2 through the communication I/F 305, Internet service provider (ISP) 6, and Internet 5.

### User Terminal

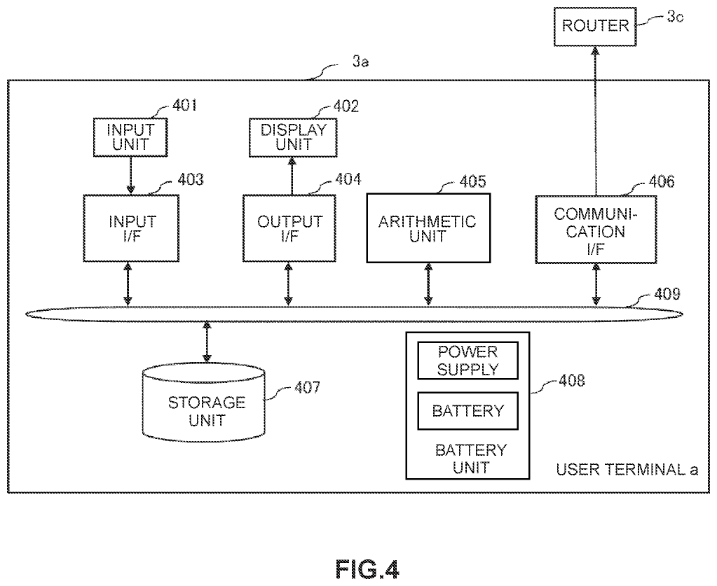

FIG. 4 is a function block diagram of a user terminal shown in FIG. 1. While FIG. 4 shows a function block diagram of the user terminal 3a as an example, the same applies to the other user terminal 3b. As shown in FIG. 4, the user terminal 3a includes an input unit 401, a display unit 402, an input I/F 403, an output I/F 404, an arithmetic unit 405, a communication I/F 406, a storage unit 407, and an internal bus 409 that connects these components to each other. The user terminal 3a also includes a battery unit 408 including a power supply and a battery. The arithmetic unit 405 is implemented by, for example, memories (not shown), such as a ROM, which stores programs, and a RAM, which temporarily stores data or the like under computation, and a processor (not shown), such as a CPU, that reads and executes the programs stored in the ROM.

The input unit 401 includes, for example, a keyboard, a mouse, and the like. The input unit 401 outputs, to the input I/F 403, input information, such as a request to access a desired terminal 4, an ID and a password inputted when performing a login for tunneling connection, and a maintenance/situation-grasp work request (to be discussed later).

The input I/F 403 transmits the input information, such as the access request, the ID and password, and the maintenance/situation-grasp work request, to the cloud server 2 through the internal bus 409, communication I/F 406, and router 3c. The output I/F 404 captures a measurement value from one of the terminal 4a to 4c included in the terminals 4 tunneling-connected in response to the maintenance/situation-grasp work request through the communication I/F 406 and outputs the measurement value to the display unit 402 so that the measurement value is displayed on the display screen.

The storage unit 407 stores the IP address of the user terminal 3a, parameters used by the arithmetic unit 405 to perform arithmetic operations, and the measurement values of the target terminals or target devices acquired in response to maintenance/situation-grasp work requests. The arithmetic unit 405 has a function of reading a desired application program from the ROM (not shown), executing it, and outputting the operation result to the display unit 402 through the internal bus 409 and output I/F 404.

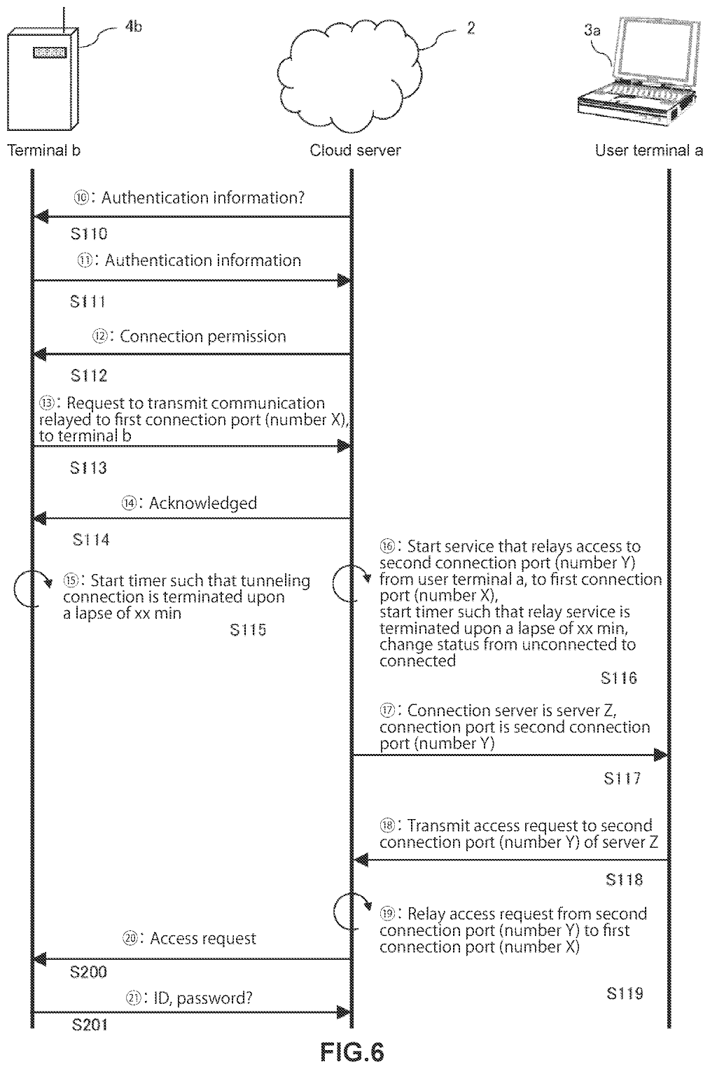

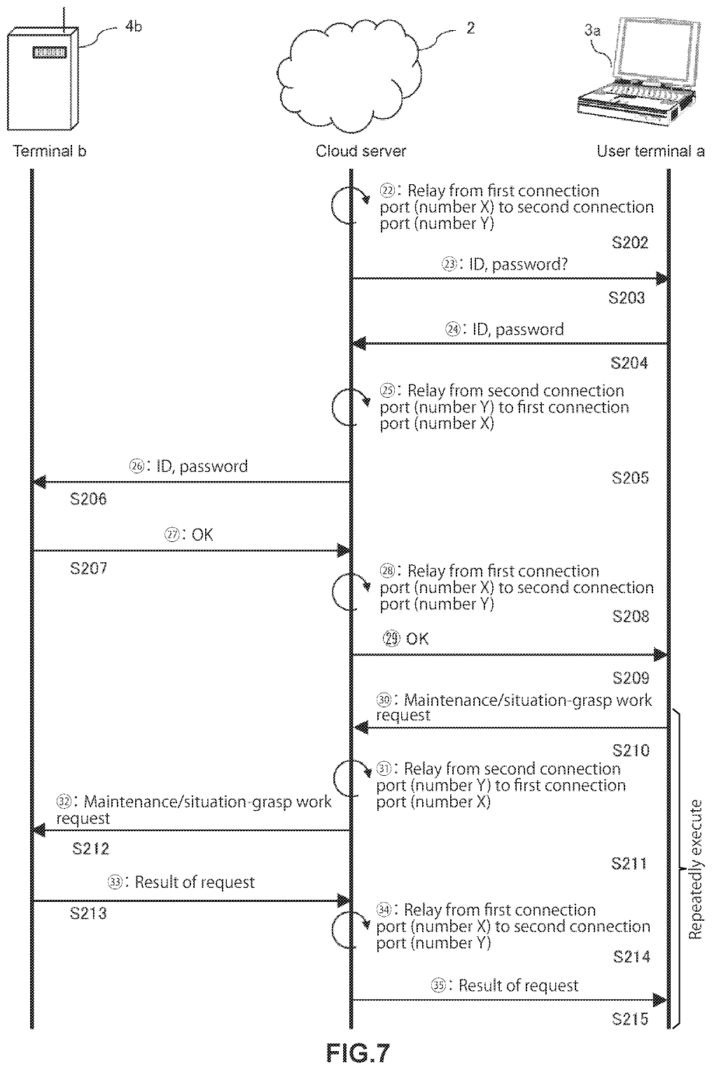

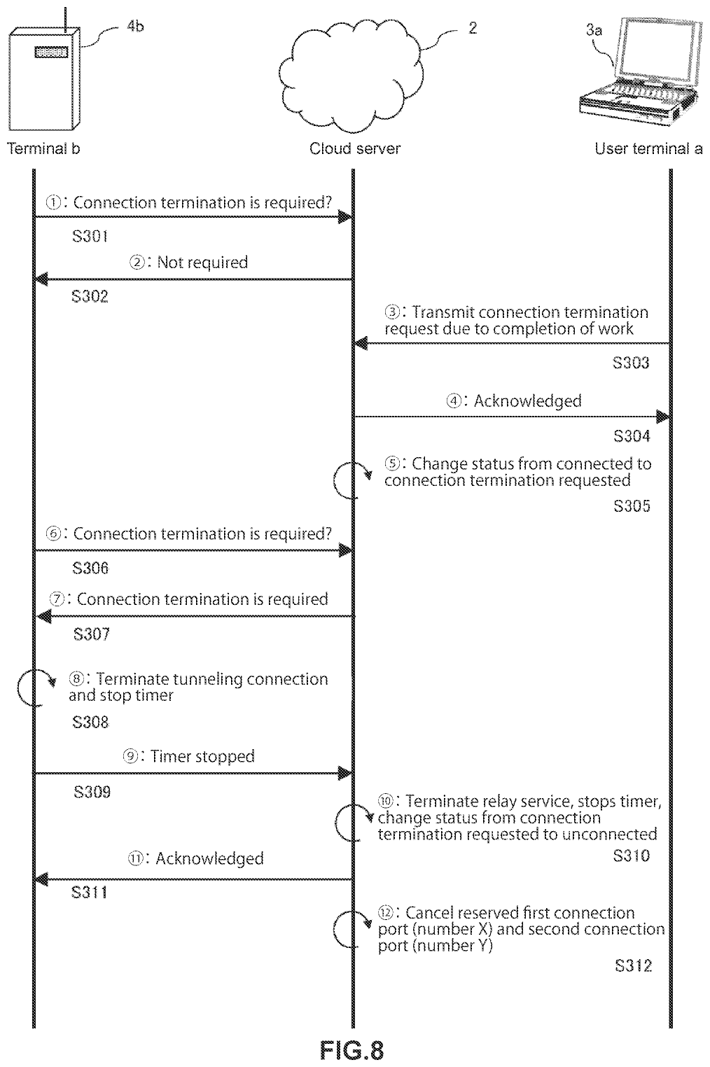

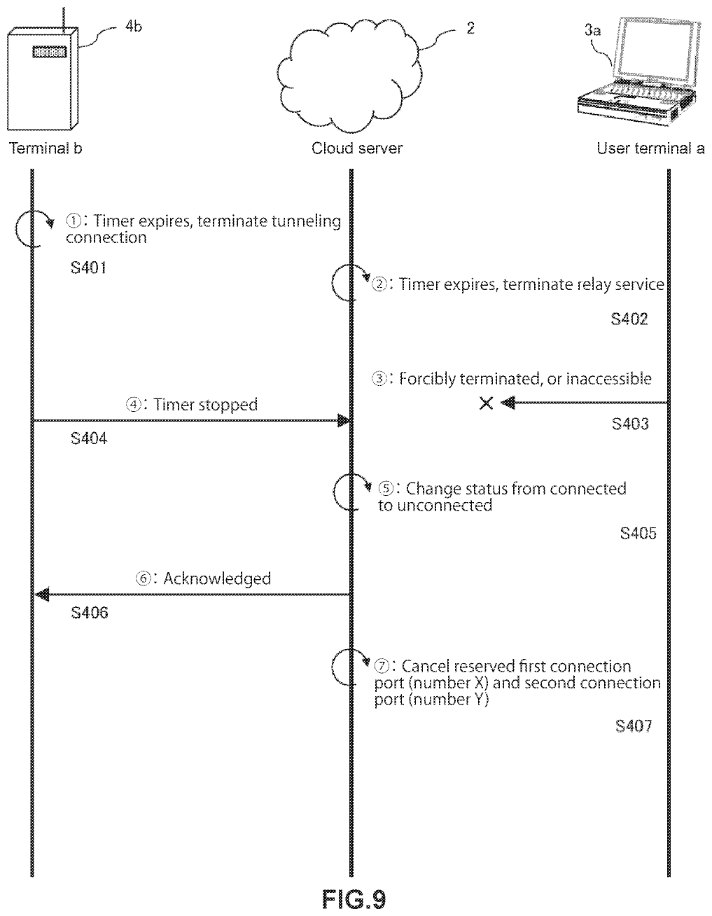

Next, the overall operation of the remote monitoring system 1 will be described. a case in which the user terminal 3a and terminal 4b are tunneling connected will be described. FIGS. 6 and 7 are schematic sequence diagrams of the remote monitoring system. FIG. 8 is a schematic sequence diagram of the remote monitoring system when the user instructs the cloud server to terminate the tunneling connection. FIG. 9 is a schematic sequence diagram of the remote monitoring system when the tunneling connection is terminated using a timer function.

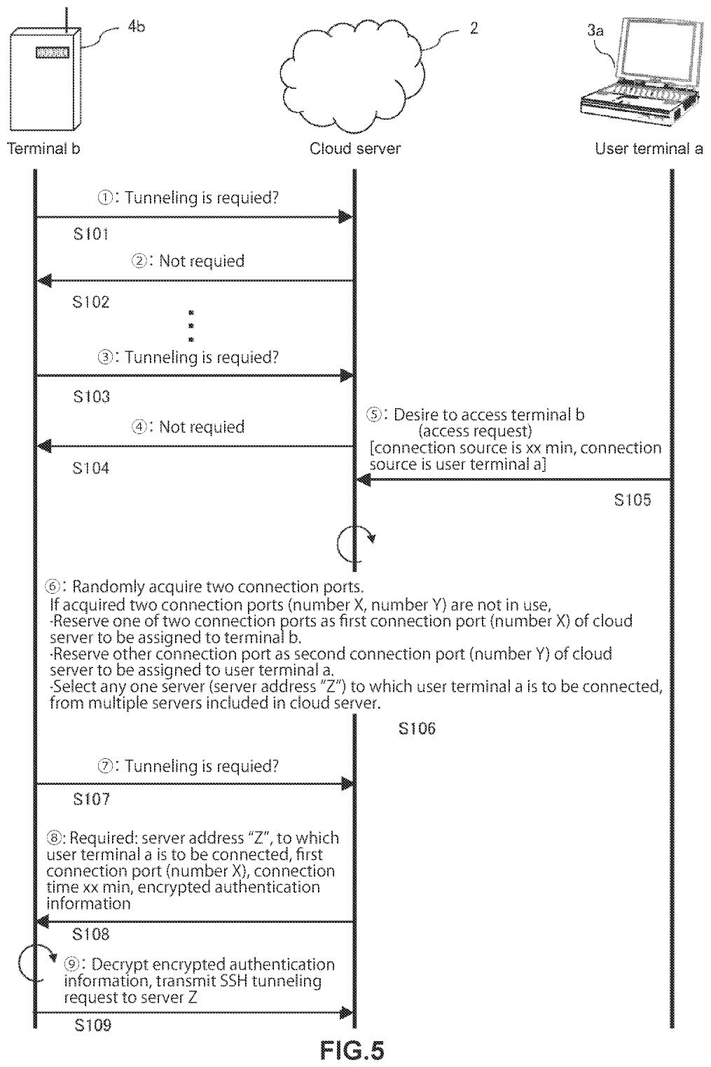

First, as shown in FIG. 5, the access request monitor 301 of the terminal 4b (FIG. 3) inquires of the cloud server 2 whether a request to access a desired terminal 4 has been received (tunneling is required), in the predetermined cycle through the communication I/F 305, Internet service provider (ISP) 6, and Internet 5 (S101). If the access request receiver 207 of the cloud server 2 has received no access request from the user terminal 3a, it transmits information indicating that tunneling is not required, to the terminal 4b through the Internet 5 and Internet service provider (ISP) 6 (S102). As shown in FIG. 5, this step is performed in the predetermined cycle, as with S103 and S104.

The user terminal 3a transmits a request to access the terminal 4b including, for example, a predetermined connection time and the IP address of the user terminal 3a itself, which is the connection source, to the cloud server 2 through the communication I/F 406 and router 3c (S105).

The access request receiver 207 of the cloud server 2 receives the request to access the terminal 4b, from the user terminal 3a, and the identification information manager 205 of the cloud server 2 accesses the user terminal storage unit 210 and identifies the connection source as the user terminal 3a on the basis of the IP address included in the access request. The identification information manager 205 also accesses the terminal identification information storage unit 209 and acquires identification information of the terminal 4b, which is the connection destination. Then, the connection port assigner 212 of the cloud server 2 randomly acquires two connection ports. If the acquired two connection ports (number X, number Y) are not in use, the connection port assigner 212 reserves one of two connection ports as a first connection port (number X) of the cloud server 2 to be assigned to the terminal 4b, as well as reserves the other connection port as a second connection port (number Y) of the cloud server 2 to be assigned to the user terminal 3a. In addition, the connection port assigner 212 selects anyone server (server address “Z”) to which the user terminal 3a is to be connected, from the multiple servers included in the cloud server 2 (S106).

Then, the access request receiver 207 of the cloud server 2 receives information indicating whether an access request has been received (tunneling is required), from the access request monitor 301 of the terminal 4b (S107). The connection port assigner 212 of the cloud server 2 transmits information indicating that tunneling is required, together with the server address “Z” (hereafter referred to as the server Z), to which the user terminal 3a is to be connected, the first connection port (number X), a predetermined connection time, and encrypted authentication information to the terminal 4b through the Internet 5 and Internet service provider (ISP) 6 (S108).

The authentication information decrypter 303 of the terminal 4b decrypts the encrypted authentication information received from the cloud server 2. The tunneling request generator 302 of the terminal 4b generates a tunneling request and transmits the generated tunneling request to the server Z included in the cloud server 2 through the communication I/F 305 and Internet service provider (ISP) 6 using, for example, SSH (S109).

Then, as shown in FIG. 6, the server Z transmits a request to transmit authentication information, to the terminal 4b through the Internet 5 and Internet service provider (ISP) 6 (S110). The authentication information decrypter 303 of the terminal 4b transmits the decrypted authentication information to the server Z through the communication I/F 305 and Internet service provider (ISP) 6 using, for example, SSH (S111).

The authentication unit 211 of the server Z determines whether tunneling can be performed, on the basis of the received authentication information and transmits a connection permission notification to the terminal 4b through the Internet 5 and Internet service provider (ISP) 6 (S112). The tunneling request generator 302 of the terminal 4b receives the connection permission notification from the server Z through the communication I/F 305 and internal bus 310 and transmits a request to transmit, to the tunneling request generator 302, a communication relayed to the first connection port (number X), to the server Z through the Internet service provider (ISP) 6 and Internet 5 (S113).

Then, the access request receiver 207 of the server Z transmits a signal indicating that the request has been acknowledged (Ack), to the terminal 4b through the Internet 5 and Internet service provider (ISP) 6 (S114). The tunneling connection termination executor 308 of the terminal 4b starts the timer (not shown) such that tunneling connection is terminated upon a lapse of the predetermined connection time previously received from the connection port assigner 212 of the server Z (S115). The relay unit 206 of the server Z starts a service that relays an access to the second connection port (number Y) from the user terminal 3a to the first connection port (number X). The connection time manager 213 of the server Z starts the timer (not shown) such that the relay service is terminated upon a lapse of the predetermined connection time (S116). The relay unit 206 changes the tunneling connection status from unconnected to connected.

The connection port assigner 212 of the server Z transmits information indicating that the server to which the user terminal 3a is to be connected is the server Z and the connection port is the second connection port (number Y), to the user terminal 3a (S117). The user terminal 3a transmits an access request to the second connection port (number Y) of the server Z (S118). The relay unit 206 of the server Z relays the access request from the second connection port (number Y) to the first connection port (number X) (S119) and transmits it to the terminal 4b through the communication I/F 208, Internet 5, and Internet service provider (ISP) 6 (S200).

The login authentication unit 309 of the terminal 4b transmits a request to transmit the ID and password of the user terminal 3a, to the server Z through the communication I/F 305, Internet service provider (ISP) 6, and Internet 5 (S201).

Then, as shown in FIG. 7, the relay unit 206 of the server Z relays the request to transmit the ID and password, from the first connection port (number X) to the second connection port (number Y) (S202) and transmits it to the user terminal 3a (S203). The communication I/F 406 of the user terminal 3a receives the request to transmit the ID and password, and the input unit 401 of the user terminal 3a receives the ID and password required to perform a login for tunneling connection and transmits the ID and password to the server Z through the input I/F 403, internal bus 409, and communication I/F 406 (S204).

The relay unit 206 of the server Z relays the ID and password of the user terminal 3a from the second connection port (number Y) to the first connection port (number X) (S205) and transmits them to the terminal 4b through the communication I/F 208, Internet 5, and Internet service provider (ISP) 6 (S206). The login authentication unit 309 of the terminal 4b performs login authentication on the basis of the ID and password of the user terminal 3a transmitted from the server Z and transmits information indicating that the login authentication has been OK (permission notification), to the server Z through the Internet service provider (ISP) 6 and Internet 5 (S207).

The relay unit 206 of the server Z relays the information indicating that the login authentication has been OK (permission notification), from the first connection port (number X) to the second connection port (number Y) (S208) and transmits it to the user terminal 3a (S209).

The communication I/F 406 of the user terminal 3a receives the information indicating that the login authentication has been OK (permission notification), and the input unit 401 of the user terminal 3a receives a maintenance/situation-grasp work request and transmits it to the server Z through the input I/F 403, internal bus 409, and communication I/F 406 (S210).

The relay unit 206 of the server Z relays the maintenance/situation-grasp work request from the second connection port (number Y) to the first connection port (number X) (S211) transmits it to the terminal 4b through the communication I/F 208, Internet 5, and Internet service provider (ISP) 6 (S212).

The measurement value acquisition unit 304 of the terminal 4b receives the maintenance/situation-grasp work request through the communication I/F 305, accesses the storage unit 306 through the internal bus 310, reads a measurement value stored in the storage unit 306 and a process result corresponding to the work request, and transmits the measurement value and the process result as a result of the maintenance/situation-grasp work request to the server Z through the Internet service provider (ISP) 6 and Internet 5 (S213).

The relay unit 206 of the server Z relays the measurement value of the target terminal or target device and the process result corresponding to the maintenance/situation-grasp work request from the first connection port (number X) to the second connection port (number Y) (S214) transmits them as a result of the work request to the user terminal 3a (S215).

Next, a schematic sequence of the remote monitoring system 1 when the user instructs the cloud server to terminate the tunneling connection will be described. As shown in FIG. 8, the tunneling connection termination request monitor 307 of the terminal 4b inquires of the server Z whether a tunneling connection termination request has been received, in a predetermined cycle through the communication I/F 305, Internet service provider (ISP) 6, and Internet 5 (S301). If the access request receiver 207 of the server Z has received no tunneling connection termination request from the user terminal 3a, it transmits information indicating that the tunneling connection need not be terminated, to the terminal 4b through the Internet 5 and Internet service provider (ISP) 6 (S302).

When the user terminal 3a completes the work, it receives a tunneling connection termination request through the input unit 401 and transmits it to the server Z through the input I/F 403, internal bus 409, and communication I/F 406 (S303). The access request receiver 207 of the server Z receives the tunneling connection termination request and transmits information indicating the request has been acknowledged (Ack), to the user terminal 3a (S304). The access request receiver 207 then changes the tunneling connection status from connected to connection termination requested (S305).

The tunneling connection termination request monitor 307 of the terminal 4b inquires of the server Z whether a tunneling connection termination request has been received, through the communication I/F 305, Internet service provider (ISP) 6, and Internet 5 (S306). By this point in time, the tunneling connection status has been changed from connected to connection termination requested and therefore the access request receiver 207 of the server Z transmits the tunneling connection termination request to the terminal 4b through the Internet 5 and Internet service provider (ISP) 6 (S307).

Upon receipt of the tunneling connection termination request from the tunneling connection termination request monitor 307 through the internal bus 310, the tunneling connection termination executor 308 of the terminal 4b terminates the tunneling connection and stops the timer (not shown) (S308). The tunneling connection termination executor 308 then transmits information indicating that the timer has been stopped, to the server Z through the Internet service provider (ISP) 6 and Internet 5 (S309).

The relay unit 206 of the server Z terminates the relay service, and the connection time manager 213 thereof stops the timer and changes the tunneling connection status from connection termination requested to unconnected (S310). The connection time manager 213 transmits information indicating acknowledgement (Ack) to the terminal 4b through the Internet 5 and Internet service provider (ISP) 6 (S311). Then, the connection port assigner 212 of the server Z cancels the reserved first connection port (number X) and second connection port (number Y) (S312).

Next, a schematic sequence of the remote monitoring system 1 when the tunneling connection is terminated using a timer function will be described. As shown in FIG. 9, when the timer expires with a lapse of the predetermined time, which is the tunneling connection time, the tunneling connection termination executor 308 of the terminal 4b terminates the tunneling connection (S401). Similarly, the timer of the connection time manager 213 of the server Z expires with a lapse of the predetermined time, which is the tunneling connection time, and the relay unit 206 thereof terminates the relay service (S402). Thus, the tunneling connection of the user terminal 3a is forcibly terminated, disabling the user terminal 3a from accessing the server Z (S403).

The tunneling connection termination executor 308 of the terminal 4b transmits a notification indicating that the timer has been stopped, to the server Z through the Internet service provider (ISP) 6 and Internet 5 (S404). The connection time manager 213 of the server Z changes the tunneling connection status from connected to unconnected (S405). The connection time manager 213 then transmits information indicating acknowledgement (Ack) to the terminal 4b through the Internet 5 and Internet service provider (ISP) 6 (S406). Then, the connection port assigner 212 of the server Z cancels the reserved first connection port (number X) and second connection port (number Y) (S407). As seen above, the timer expires with a lapse of the set time (predetermined connection time), resulting in the automatic termination of the tunneling connection. Thus, even if the user forgets to transmit a tunneling connection termination request after the work is complete, he or she can be prevented from forgetting to close the connection ports.

### Process Flow of Cloud Server

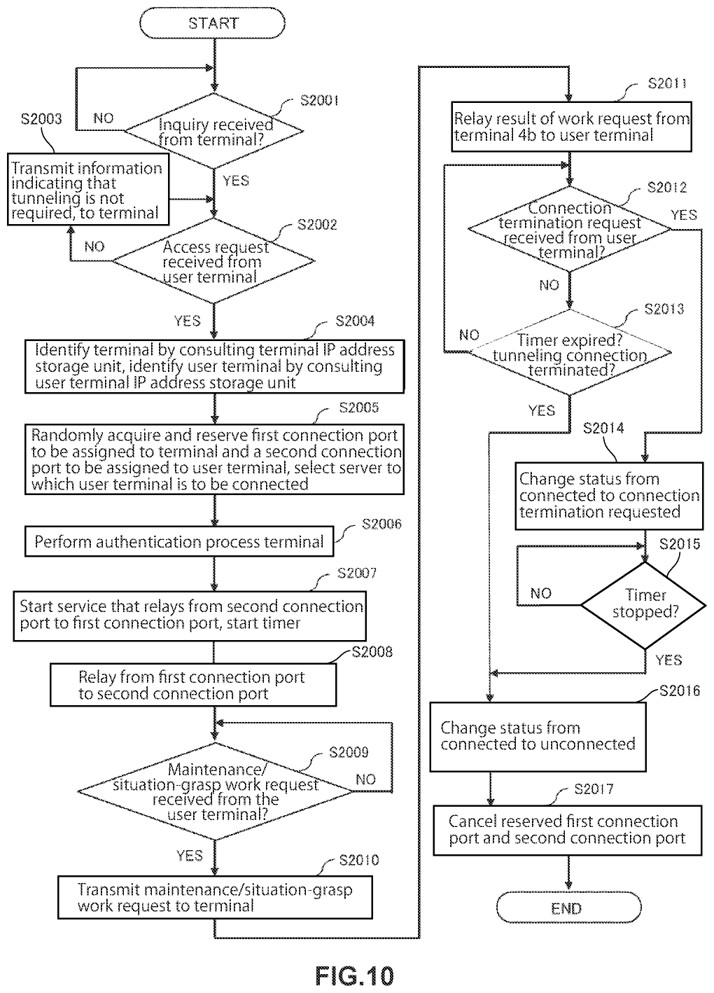

FIG. 10 is a flowchart showing the process flow of the cloud server 2 shown in FIG. 2. As shown in FIG. 10, in step S2001, the access request receiver 207 determines whether an inquiry has been received from the terminal 4b. Specifically, the access request receiver 207 determines whether an inquiry about whether an access request has been received (tunneling is required) has been received from the terminal 4b. If no such inquiry has been received, the access request receiver 207 waits while repeating step S2001. On the other hand, if an inquiry about whether an access request has been received (tunneling is required) has been received from the terminal 4b, the process proceeds to step S2002.

In step S2002, the access request receiver 207 determines whether an access request has been received from the user terminal 3a. If it is determined that no access request has been received from the user terminal 3a, the process proceeds to step S2003. The access request receiver 207 transmits information indicating that tunneling is not required, to the terminal 4b through the Internet 5 and Internet service provider (ISP) 6, and the process returns to step S2002. On the other hand, if an access request has been received from the user terminal 3a, the process proceeds to step S2004.

In step S2004, the identification information manager 205 identifies the terminal 4b by consulting the terminal identification information storage unit 209, as well as identifies the user terminal 3a by consulting the user terminal storage unit 210. More specifically, the identification information manager 205 accesses the user terminal storage unit 210 and identifies the connection source as the user terminal 3a on the basis of identification information included in the access request. Also, the identification information manager 205 accesses the terminal identification information storage unit 209 and acquires identification information of the terminal 4b, which is the connection destination.

In step S2005, a first connection port to be assigned to the terminal 4b and a second connection port to be assigned to the user terminal 3a are randomly acquired and reserved, and a server to which the user terminal 3a is to be connected is selected. Specifically, the connection port assigner 212 randomly acquires two connection ports. If the acquired two connection ports (number X, number Y) are not in use, the connection port assigner 212 reserves one of the two connection ports as a first connection port (number X) of the cloud server 2 to be assigned to the terminal 4b, as well as the reserves the other connection port as a second connection port (number Y) of the cloud server 2 to be assigned to the user terminal 3a. In addition, the connection port assigner 212 selects any one server (server address “Z”) to which the user terminal 3a is to be connected, from the multiple servers included in the cloud server 2. The connection port assigner 212 then transmits information indicating that tunneling is required, together with the server Z, to which the user terminal 3a is to be connected, the first connection port (number X), a predetermined connection time, and encrypted authentication information to the terminal 4b through the Internet 5 and Internet service provider (ISP) 6.

In step S2006, an authentication process is performed on the terminal 4b. Specifically, the authentication unit 211 performs the authentication process by determining whether tunneling can be performed, on the basis of authentication information received from the terminal 4b. In step S2007, a service that relays an access request from the second connection port to the first connection port is started, and the timer is started. Specifically, the relay unit 206 starts a service that relays an access request transmitted to the second connection port (number Y) by the user terminal 3a to the first connection port (number X). The connection time manager 213 starts the timer such that the tunneling connection is terminated upon a lapse of the predetermined connection time. The relay unit 206 also changes the tunneling connection status from unconnected to connected.

In step S2008, a relay from the first connection port to the second connection port is performed. Specifically, the relay unit 206 relays from the first connection port (number X) to the second connection port (number Y).

In step S2009, it is determined whether a maintenance/situation-grasp work request has been received from the user terminal 3a. If no maintenance/situation-grasp work request has been received, a wait is made in step S2009. On the other hand, if a maintenance/situation-grasp work request has been received, the process proceeds to step S2010. Specifically, the access request receiver 207 determines whether it has received a maintenance/situation-grasp work request from the user terminal 3a. If no maintenance/situation-grasp work request has been received, the access request receiver 207 waits in step S2009. On the other hand, if the access request receiver 207 has received a maintenance/situation-grasp work request from the user terminal 3a through the communication I/F 208, the process proceeds to step S2010.

In step S2010, a maintenance/situation-grasp work request is transmitted to the terminal 4b. Specifically, the relay unit 206 relays a maintenance/situation-grasp work request from the second connection port (number Y) to the first connection port (number X) and transmits it to the terminal 4b through the communication I/F 208, Internet 5, and Internet service provider (ISP) 6.

In step S2011, the result of the work request from the terminal 4b is relayed to the user terminal 3a. Specifically, as a result of the maintenance/situation-grasp work request, the relay unit 206 relays the measurement value of the target terminal or target device or a processing result corresponding to the work request received from the terminal 4b, from the first connection port (number X) to the second connection port (number Y) and transmits it to the user terminal 3a.

In step S2012, it is determined whether a tunneling connection termination request has been received from the user terminal 3a. If a tunneling connection termination request has been received, the process proceeds to step S2014; if no tunneling connection termination request has been received, the process proceeds to step S2013. Specifically, the access request receiver 207 determines whether a tunneling connection termination request has been received from the user terminal 3a. If a tunneling connection termination request has been received from the user terminal 3a, the process proceeds to step S2014; if no tunneling connection termination request has been received from the user terminal 3a, the process proceeds to step S2013.

In step S2013, it is determined whether the timer has expired and the tunneling connection has been terminated. If the timer has not expired and the tunneling connection has not been terminated, the process returns to step S2012. On the other hand, if the timer has expired and the tunneling connection has been terminated, the process proceeds to step S2015. Specifically, if the predetermined time, which is the tunneling connection time, has not elapsed after the start of the timer by the connection time manager 213, the timer does not expire and therefore the relay unit 206 continues the relay service. The process returns to S2012. On the other hand, if the predetermined time, which is the tunneling connection time, has elapsed after the start of the timer by the connection time manager 213, the timer expires and therefore the relay unit 206 terminates the relay service. The process proceeds to S2015.

In step S2014, the tunneling connection status is changed from connected to connection termination requested. Specifically, the access request receiver 207 changes the tunneling connection status from connected to connection termination requested. The access request receiver 207 then transmits a tunneling connection termination request to the terminal 4b in response to an inquiry from the terminal 4b about whether a tunneling connection termination request has been received.

In step S2015, a wait is made until information indicating that the timer has been stopped comes from the terminal 4b.

In step S2016, the tunneling connection status is changed from connected or connection termination requested to unconnected. Specifically, the relay unit 206 terminates the relay service, and the connection time manager 213 stops the timer and changes the tunneling connection status from connected or connection termination requested to unconnected.

In step S2017, the reserved first connection port and second connection port are cancelled, ending the process. Specifically, the connection port assigner 212 cancels the reserved first connection port (number X) and second connection port (number Y), ending the process.

### Process Flow of Terminal

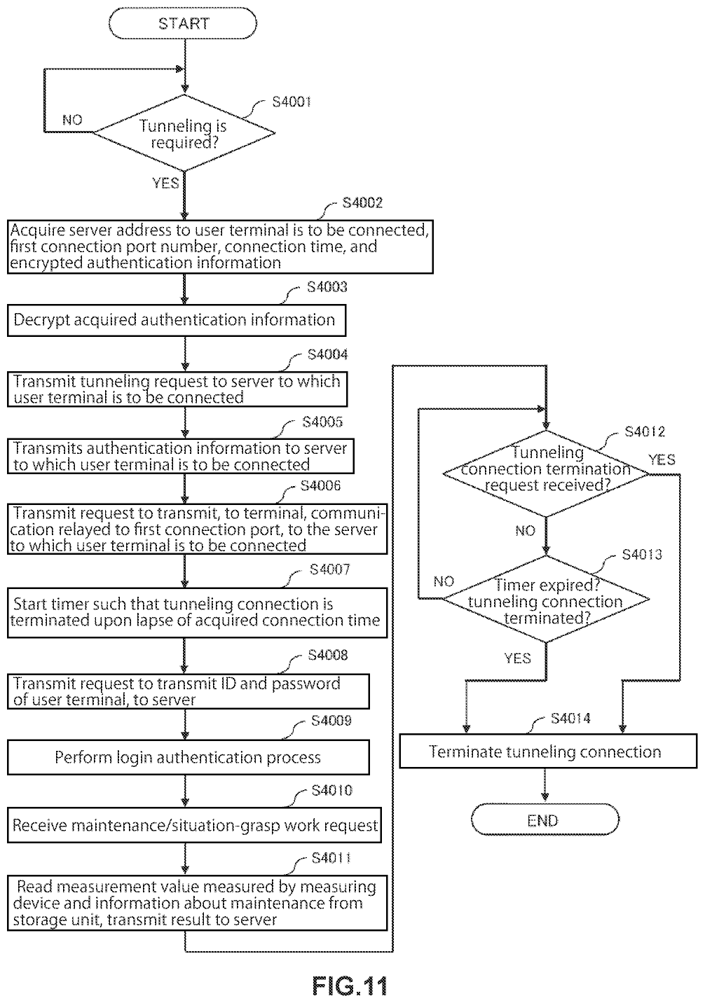

FIG. 11 is a flowchart showing the process flow of a terminal 4 shown in FIG. 3. Hereafter, the terminal 4b will be described as an example. As shown in FIG. 11, in step S4001, the access request monitor 301 determines whether tunneling is required. Specifically, the access request monitor 301 inquires of the cloud server 2 whether an access request has been received (tunneling is required), in the predetermined cycle through the communication I/F 305, Internet service provider (ISP) 6, and Internet 5. If the access request monitor 301 receives information indicating that no access request has been received, as a result of the inquiry, it waits while repeating step S4001. On the other hand, if the access request monitor 301 receives information indicating that an access request has been received, the process proceeds to step S4002.

In step S4002, a server address to which the user terminal 3a is to be connected, the first connection port number, the connection time, and encrypted authentication information are acquired. Specifically, the server address “Z” (hereafter referred to as the server Z), to which the user terminal 3a is to be connected, the first connection port (number X), the predetermined connection time, and encrypted authentication information are received from the cloud server 2 through the Internet 5, Internet service provider (ISP) 6, and communication I/F 305. Among these, the server Z and the first connection port (number X) are acquired by the tunneling request generator 302 through the internal bus 310, the predetermined connection time is acquired by the tunneling connection termination executor 308 through the internal bus 310, and the encrypted authentication information is acquired by the authentication information decrypter 303 through the internal bus 310.

In step S4003, the acquired authentication information is decrypted. Specifically, the authentication information decrypter 303 decrypts the encrypted authentication information received from the cloud server 2.

In step S4004, a tunneling request is transmitted to the server Z, to which the user terminal 3a is to be connected. Specifically, the tunneling request generator 302 generates a tunneling request and transmits the generated tunneling request to the server Z included in the cloud server 2 through the communication I/F 305 and Internet service provider (ISP) 6 using, for example, SSH.

In step S4005, the authentication information is transmitted to the server Z, to which the user terminal 3a is to be connected. Specifically, the authentication information decrypter 303 transmits the decrypted authentication information to the server Z through the communication I/F 305 and Internet service provider (ISP) 6 using, for example, SSH.

In step S4006, a request to transmit, to the terminal 4b, a communication relayed to the first connection port (number X) is transmitted to the server Z, to which the user terminal 3a is to be connected. Specifically, the tunneling request generator 302 transmits a request to transmit, to the terminal 4b, a communication relayed to the first connection port (number X), to the server Z through the Internet service provider (ISP) 6 and Internet 5.

In step S4007, the timer is started such that the tunneling connection is terminated upon a lapse of the acquired connection time. Specifically, the tunneling connection termination executor 308 starts the timer (not shown) such that the tunneling connection is terminated upon a lapse of the predetermined connection time previously received from the server Z.

In step S4008, a request to transmit the ID and password of the user terminal 3a is transmitted to the server Z. Specifically, the login authentication unit 309 transmits a request to transmit the ID and password of the user terminal 3a, to the server Z through the communication I/F 305, Internet service provider (ISP) 6, and Internet 5.

In step S4009, a login authentication process is performed. Specifically, the login authentication unit 309 performs login authentication on the basis of the ID and password of the user terminal 3a transmitted from the server Z and transmits information indicating that the login authentication has been OK (permission notification), to the server Z through the Internet service provider (ISP) 6 and Internet 5.

In step S4010, a maintenance/situation-grasp work request is received. Specifically, the measurement value acquisition unit 304 receives a maintenance/situation-grasp work request from the user terminal 3a through the communication I/F 305.

In step S4011, a measurement value measured by the measuring device and information about maintenance are read from the storage unit, and the result is transmitted to the server Z. Specifically, the measurement value acquisition unit 304 accesses the storage unit 306 through the internal bus 310, reads a measurement value of the target terminal or target device or a processing result corresponding to the work request stored in the storage unit 306, and transmits the measurement value or the like as a result of the maintenance/situation-grasp work request to the server Z through the Internet service provider (ISP) 6 and Internet 5.

In step S4012, it is determined whether a tunneling connection termination request has been received from the user terminal 3a. If a tunneling connection termination request has been received, the process proceeds to step S4014; if no tunneling connection termination request has been received, the process proceeds to step S4013. Specifically, the tunneling connection termination request monitor 307 inquires of the server Z whether a tunneling connection termination request has been received, through the communication I/F 305, Internet service provider (ISP) 6, and Internet 5. If the tunneling connection termination request monitor 307 receives information indicating that a tunneling connection termination request has been received, as a result of the inquiry, the process proceeds to step S4014; if it receives information indicating that no tunneling connection termination request has been received, the process proceeds to step S4013.

In step S4013, it is determined whether the timer has expired and the tunneling connection has been terminated. If the timer has not expired and the tunneling connection has not been terminated, the process returns to step S4012. The terminal 4b continuously communicates with the user terminal 3a, to which the second connection port is assigned, through the first connection port for the predetermined time. On the other hand, if the timer has expired and the tunneling connection has been terminated, the process proceeds to step S4014. Specifically, if the predetermined time, which is the tunneling connection time, has not elapsed after the start of the timer by the tunneling connection termination executor 308, the timer does not expire and therefore the tunneling connection is continued. The process returns to S4012. On the other hand, if the predetermined time, which is the tunneling connection time, has elapsed after the start of the timer by the tunneling connection termination executor 308, the timer expires, and the process proceeds to S4014.

In step S4014, the tunneling connection termination executor 308 terminates the tunneling connection, ending the process.

### Process Flow of User Terminal

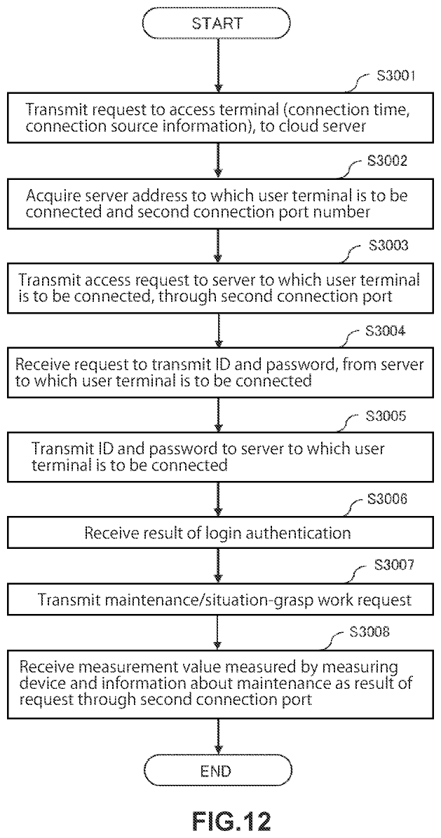

FIG. 12 is a flowchart showing the process flow of a user terminal shown in FIG. 4. Hereafter, the user terminal 3a will be described as an example. As shown in FIG. 12, in step S3001, an request to access the terminal 4b (the connection time and connection source information) is transmitted to the cloud server 2. Specifically, the user terminal 3a transmits a request to access the terminal 4b including, for example, a predetermined connection time and the IP address of the user terminal 3a itself, which is the connection source, to the cloud server 2 through the communication I/F 406 and router 3c.

In step S3002, the server address to which the user terminal 3a is to be connected and the second connection port number are acquired. Specifically, information indicating that the server to which the user terminal 3a is to be connected is the server Z and the connection port is the second connection port (number Y) is acquired from the cloud server 2.

In step S3003, an access request is transmitted to the server Z to which the user terminal 3a is to be connected, through the second connection port. Specifically, the user terminal 3a transmits an access request to the second connection port (number Y) of the server Z.

In step S3004, a request to transmit an ID and a password is received from the server to which the user terminal 3a is to be connected. Specifically, the communication I/F 406 receives a request to transmit an ID and a password, from the server Z.

In step S3005, an ID and a password are transmitted to the server Z, to which the user terminal 3a is to be connected. Specifically, the input unit 401 receives an ID and a password required to perform a login for tunneling connection and transmits them to the server Z through the input I/F 403, internal bus 409, and communication I/F 406.

In step S3006, the result of login authentication is received. Specifically, the communication I/F 406 receives information indicating that the login authentication has been OK (permission notification), from the server Z.

In step S3007, a maintenance/situation-grasp work request is transmitted. Specifically, the input unit 401 receives a maintenance/situation-grasp work request and transmits it to the server Z through the internal bus 409 and communication I/F 406.

In step S3008, a measurement value measured by the measuring device and information about maintenance are received as a result of the request through the second connection port. Specifically, the communication I/F 406 receives, as a result of the maintenance/situation-grasp work request, a measurement value of the target terminal or target device and a processing result corresponding to the work request from the server Z, ending the process.

Although not shown in FIG. 12, the measurement value of the target terminal or target device and the processing result corresponding to the work request received as a result of the maintenance/situation-grasp work request are displayed on the display screen of the display unit 402 through the output I/F 404. Thus, the user 3, who is the owner of the user terminal 3a, is able to easily consider the need to maintain the target terminal or target device and details of the maintenance.

While, in the present embodiment, the configuration in which the measurement value of the target terminal or target device is transmitted from the terminal 4 to the cloud server 2 in the predetermined cycle through the Internet service provider (ISP) 6 and Internet 5 using IoT has been described as an example, this configuration does not have to be employed. For example, a personal computer, smartphone (mobile phone), tablet, or the like may be used in place of the terminals 4 including the terminal 4a to 4c.

According to the present embodiment, a remote monitoring system can be provided that allows a user terminal to access multiple terminals connected to the Internet through an Internet service provider at a desired timing.

According to the present embodiment, the user terminal and one of the terminals are tunneling connected to each other. Thus, the user is able to timely grasp the need to maintain the target terminal or target device and to easily consider details of the maintenance.

Also, the user can be prevented from forgetting to close the first and second connection ports randomly assigned to one terminal and the user terminal during the tunneling connection, allowing for an improvement in security.

In the above embodiment, the configuration in which the user terminals 3 and terminals 4 are able to communicate with each other through the cloud server 2 has been described. To allow the user terminals 3 and lower-order devices, such as measuring devices or cameras, connected to the lower-order connection ports of the terminals 4 to communicate with each other in this configuration, the following process is required. Note that the connection ports of the terminals 4 are referred to as the “lower-order connection ports” in order to distinguish them from the connection ports of the cloud server 2.

That is, the user terminal 3, cloud server 2, and terminal 4 perform steps S101 to S208 in FIGS. 5 to 7 and thus the user terminal 3 and terminal 4 are communicatively connected to each other; and subsequently, the user terminal 3 receives inputs a predetermined request to the terminal 4, which then communicatively connects (relays) a lower-order device connected to the lower-order connection port thereof and the user terminal 3. However, input of such a request is typically performed from the user terminal on the command line and therefore is a troublesome work to a user who is not accustomed to operation.

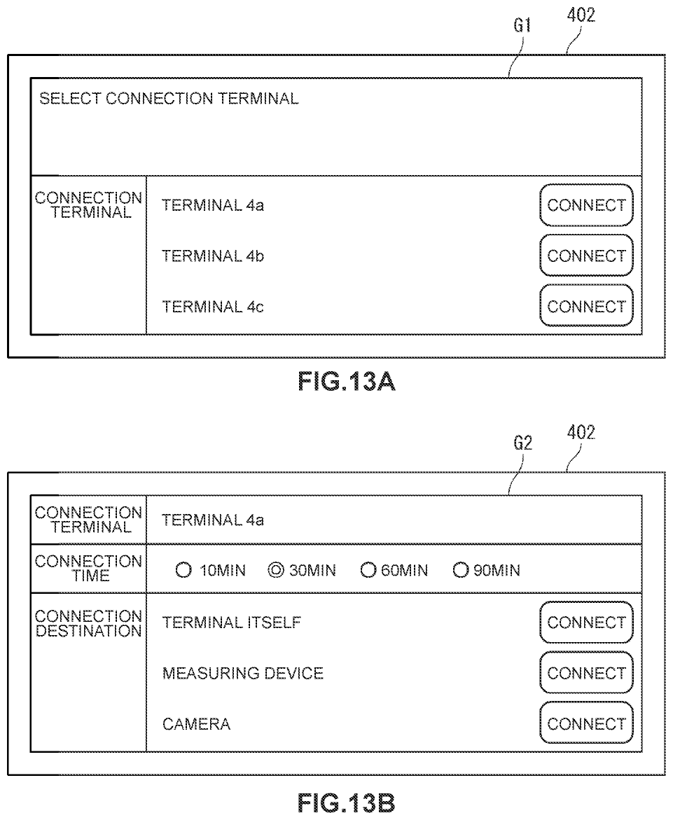

For this reason, the following configuration may be employed: for example, as shown in FIG. 13A, a terminal selection screen G1 indicating the terminals 4 (4a to 4c) serving as candidate connection terminals and including buttons for selecting the connection terminal is displayed on the display unit 402 of the user terminal 3; when the connection terminal is selected on the terminal selection screen G1 by a button operation, a connection destination selection screen G2 indicating the candidate connection destinations (the terminal 4 itself, a measuring device, a camera, and the like connected to the lower-order connection ports thereof) of the selected terminal and buttons for selecting the connection destination is displayed, as shown in FIG. 13B; and then the user terminal 3 is automatically connected to the connection destination selected by a button operation on the connection destination selection screen G2. Note that if the terminal itself is selected on the connection destination selection screen G2, the same operations as those described in the above embodiment are performed. As one example, the terminal selection screen G1 and connection destination selection screen G2 are displayed on the display unit 402 of the user terminal 3 when the browser software of the user 3 accesses the cloud server 2 serving as a Web server.

Hereafter, an example in which the user terminal 3 is automatically connected to a measuring device connected to the lower-order connection port (number A) of a terminal 4 will be described. Since many portions of this automatic connection operation are the same as many of steps S101 to S208 in FIGS. 5 to 7, the different portions will be mainly described.

First, it is assumed the terminal 4b is selected on the terminal selection screen G1 and a measuring device is selected on the connection destination selection screen G2. Then, in S105 of FIG. 5, the user terminal 3a transmits, to the cloud server 2, a request to access the terminal 4b, including a predetermined connection time and the IP address of the user terminal 3a itself, as well as information indicating a measuring device serving as a connection destination (e.g., the lower-order connection port (number A) or a unique identification number assigned to the measuring device, etc.).

Then, in S106, the cloud server 2 reserves a first connection port (number X) and a second connection port (number Y), as well as selects a server Z, to which the user terminal 3a is to be connected. Then, in S107, the cloud server 2 receives an inquiry about whether tunneling is required, from the terminal 4b. In S108, the cloud server 2 transmits, to the terminal 4b, information indicating that tunneling is required, together with information indicating the server Z, to which the user terminal 3a is to be connected, the first connection port (number X), a predetermined connection time, encrypted authentication information, and a measuring device. This information transmitted to the terminal 4b and the above access request correspond to a request to access the measuring device connected to the terminal 4b.

Then, the process proceeds to S109 to S206, and the terminal 4b performs login authentication on the basis of the ID and password of the user terminal 3a transmitted from the server Z. If the authentication has been OK, the terminal 4b transfers the information received from the server Z to the lower-order connection port (number A) to which the measuring device is connected, as well as transfers information received from the lower-order connection port (number A) to the first connection port (number X) of the server Z. Then, in S207, the terminal 4b transmits information indicating that the authentication has been OK (permission notification), to the server Z.

Thus, the user terminal 3a and the measuring device connected to the lower-order connection port (number A) of the terminal 4b are communicatively tunneling connected to each other, so that the request of the user terminal 3a is directly inputted to the measuring device.

That is, when the terminal 4b receives the request to access the measuring device connected to the terminal 4b, from the cloud server 2, it transfers (relays) the communication transmitted from the user terminal 3a through the first connection port (number X), second connection port (number Y), and cloud server 2, to the measuring device. Thus, the user terminal 3a and measuring device are able to directly communicate with each other.

As seen above, if the user terminal 3a desires to directly communicate with the measuring device or the like connected to the lower-order connection port of the terminal 4b, the user terminal 3a transmits an access request including information indicating the lower-order device serving as a connection destination, to the lower-order device. Thus, the user is able to automatically connect the user terminal 3a to the lower-order device without having to perform a troublesome request input operation.

The timing when the terminal 4b transfers a communication between the server Z and the lower-order connection port need not be immediately before S207 and may be, for example, before or after S109. The timing may be determined appropriately in accordance with the configuration without departing from the scope of the present invention. Also, in the above embodiment, the user selects the connection destination by operating a connection button displayed on the display unit 402. Alternatively, for example, the user may input a command character string including the selected connection destination.

The present invention is not limited to the above-described embodiment and includes various modifications. For example, the above embodiment has been described in detail to clarify the present invention, and the invention should not be construed as necessarily including all the described components.

### REFERENCE SIGNS LIST

1 . . . remote monitoring system
2 . . . cloud server
3 . . . user
3a . . . user terminal
3b . . . user terminal
3c . . . router
4 . . . terminal
4a . . . terminal
4b . . . terminal
4c . . . terminal
5 . . . Internet
6 . . . Internet service provider (ISP)
7 . . . tunneling
8 . . . measuring device
201 . . . input unit
202 . . . display unit
203 . . . input I/F
204 . . . output I/F
205 . . . identification information manager
206 . . . relay unit
207 . . . access request receiver
208 . . . communication I/F
209 . . . terminal identification information storage unit
210 . . . user terminal storage unit
211 . . . authentication unit
212 . . . connection port assigner
213 . . . connection time manager
214 . . . internal bus
301 . . . access request monitor
302 . . . tunneling request generator
303 . . . authentication information decrypter
304 . . . measurement value acquisition unit
305 . . . communication I/F
306 . . . storage unit
307 . . . tunneling connection termination request monitor
308 . . . tunneling connection termination executor
309 . . . login authentication unit
310 . . . internal bus
401 . . . input unit
402 . . . display unit
403 . . . input I/F
404 . . . output I/F
405 . . . arithmetic unit
406 . . . communication I/F
407 . . . storage unit
408 . . . battery unit
409 . . . internal bus
G1 . . . terminal selection screen
G2 . . . connection destination selection screen

1. A remote monitoring system comprising:
a plurality of terminals connected to the Internet through an Internet service provider having a global IP address, the terminals being assigned private IP addresses;
a cloud server connected to the Internet; and
a user terminal connected to the cloud server, wherein the cloud server assigns a first connection port to one of the terminals and assigns a second connection port to the user terminal, and
the one terminal and the user terminal communicate with each other through the first connection port, the second connection port, and the cloud server.

2. The remote monitoring system of claim 1, wherein the cloud server randomly assigns the first connection port and the second connection port to the one terminal and the user terminal.

3. The remote monitoring system of claim 1, wherein the user terminal transmits a request to access the one of the terminals, to the cloud server.

4. The remote monitoring system of claim 3,
the cloud server comprises a connection port assigner configured to, for each of a request to access the one of the terminals transmitted from the user terminal, assign a different first connection port to the one of the terminals and assign a different second connection port to the user terminal.

5. The remote monitoring system of claim 4, wherein
the cloud server comprises a connection time manager configured to be able to, for a predetermined time, continue a communication between the one terminal to which the first connection port is assigned and the user terminal to which the second connection port is assigned.

6. The remote monitoring system of claim 5, wherein the user terminal transmits, to the cloud server, at least an IP address of the user terminal, one of the terminals, the one terminal being a terminal that the user terminal desires to access, and a connection time.

7. The remote monitoring system of claim 6, wherein
upon a lapse of the connection time transmitted from the user terminal, the connection time manager terminates a communication between the one terminal and the user terminal through the first connection port and the second connection port.

8. The remote monitoring system of claim 7, wherein
the terminals are connected to measuring devices and/or imaging devices wired or wirelessly and transmit measurement values of target terminals or target devices measured by the measuring devices and/or image data of target terminals or target devices captured by the imaging devices to the cloud server in a predetermined cycle through the Internet service provider and the Internet.

9. The remote monitoring system of claim 1, wherein
the user terminal transmits, to the cloud server, a request to access a lower-order device connected to the one of the terminals, and
upon receipt of the access request from the cloud server, the one terminal connects a communication with the user terminal to the lower-order device.

10. The remote monitoring system of claim 9, wherein
the user terminal displays a terminal selection screen for selecting one of the terminals and a connection destination selection screen for selecting a connection destination of the one terminal selected on the terminal selection screen and, when a lower-order device connected to the one terminal is selected as the connection destination on the connection destination selection screen, transmits a request to access the lower-order device, to the cloud server.

11. A plurality of terminals for use in remote monitoring systems, the terminals being connected to the Internet through an Internet service provider having a global IP address and assigned private IP addresses, wherein
the terminals are connectable to a cloud server through the Internet and are able to communicate with a user terminal through the cloud server, and
the terminals are assigned a first connection port different from a second connection port assigned to the user terminal by the cloud server and are able to communicate with the user terminal through the first connection port and the second connection port.

12. The terminals for use in remote monitoring systems of claim 11, wherein
the first connection port different from the second connection port assigned to the user terminal by the cloud server is randomly assigned.

13. The terminals for use in remote monitoring systems of claim 12, wherein the terminals continuously communicate with the user terminal to which the second connection port is assigned, through the first connection port for a predetermined time.

14. The terminals for use in remote monitoring systems of claim 13, each comprising a tunneling connection termination executor configured to, upon a lapse of a predetermined time, terminate a tunneling connection in which the terminals communicate with the user terminal to which the second connection port is assigned, through the first connection port.

15. The terminals for use in remote monitoring systems of claim 11, wherein
the terminals each have a lower-order device connected thereto and, upon receipt of a request to access the lower-order device, from the cloud server, enable the user terminal and the lower-order device to communicate with each other.

16. A remote monitoring program for causing a processor to perform functions of:
assigning a first connection port to one of a plurality of terminals connected to the Internet through an Internet service provider having a global IP address, the terminals being assigned private IP addresses;
assigning a second connection port to a user terminal connected to a cloud server connected to the Internet; and
randomly assigning the first connection port and the second connection port.

17. The remote monitoring program of claim 16, wherein the remote monitoring program causes a processor to perform a function of, for a predetermined time, continuing a communication between the one terminal to which the first connection port is assigned and the user terminal to which the second connection port is assigned.
